(19) United States
(12) Patent Application Publication
(10) Pub. No.: US 2018/0260791 A1
(43) Pub. Date: Sep. 13, 2018

(54) SOCIAL APPLICATION FOR ORGANIZING GATHERINGS

(71) Applicant: JACQUELINE A. BERCHIELLI, NEW YORK, NY (US)

(72) Inventor: JACQUELINE A. BERCHIELLI, NEW YORK, NY (US)

(21) Appl. No.: 15/915,834

(22) Filed: Mar. 8, 2018

Related U.S. Application Data
(60) Provisional application No. 62/468,683, filed on Mar. 8, 2017.

(51) Int. Cl. G06Q 10/10; G06Q 50/00

(52) U.S. Cl. CPC G06Q 10/1095; G06Q 50/01

(57) ABSTRACT

Systems and methods are provided for displaying locations of multiple users of a social networking application. A first indicator is dynamically displayed on a display of a mobile device of a first user of the social networking application representing a current location of the first user. The first indicator is selected from a predetermined list of indicators representing possible activities and mental states for the first user. A plurality of indicators represents a corresponding plurality of other users are dynamically displayed. Each of the plurality of indicators is selected from the predetermined list of indicators by their respective user and displayed at a location associated with the respective user. Each indicator has an associated interface, accessible via the mobile device, to allow communication with the respective user

### CROSS-REFERENCE TO RELATED APPLICATION

This application claims the benefit of U.S. Provisional Patent Application No. 62/468,683 filed Mar. 8, 2017, and entitled MOBILE DEVICE APPLICATION FOR ORGANIZING EVENTS, which is incorporated herein by reference in its entirety.

### TECHNICAL FIELD

The present invention relates generally to social networking applications, and more particularly to a social application for organizing gatherings.

### BACKGROUND

A social networking service is an online platform that people use to build social networks or social relations with other people. Social networking sites allow users to share ideas, digital photos and videos, posts, and to inform others about online or real-world activities and events with people in their network. While in-person social networking has existed since the earliest development of towns, the Internet enables people to connect with others who live in different locations, ranging from across a city to across the world. Depending on the social media platform, members may be able to contact any other member, although some services require members to have a preexisting connection to contact other members.

### SUMMARY

In one example, a method is provided for displaying locations of multiple users of a social networking application. A first indicator is dynamically displayed on a display of a mobile device of a first user of the social networking application representing a current location of the first user. The first indicator is selected from a predetermined list of indicators representing possible activities and mental states for the first user. A plurality of indicators represents a corresponding plurality of other users are dynamically displayed. Each of the plurality of indicators is selected from the predetermined list of indicators by their respective user and displayed at a location associated with the respective user. Each indicator has an associated interface, accessible via the mobile device, to allow communication with the respective user.

In another example, a social networking application for a mobile device is provided. A global positioning system interface receives a location of the mobile device from a GPS associated with the device. A network interface periodically sends the location of the mobile device to an associated server and receives locations associated with a plurality of users of the social networking application via an associated network connection. A user interface includes a menu system that allows a first user to select an indicator from a predetermined list of indicators representing possible activities and mental states. A display interface dynamically displays a first indicator on a display of the mobile device of a first user of the social networking application representing a current location of the first user and a plurality of indicators representing the plurality of users. Each of the plurality of indicators is selected from a predetermined list of indicators representing possible activities and mental states for the user by their respective user and is displayed at a location associated with the respective user. Each indicator has an associated interface to allow communication with the respective user.

In a further example, another method is provided for displaying locations of multiple users of a social networking application. A first indicator is dynamically displayed on a display of a mobile device of a first user of the social networking application representing a current location of the first user. The first indicator is selected from a predetermined list of indicators representing possible activities and mental states for the first user. A plurality of filter settings are selected at the mobile device. A plurality of indicators are dynamically displayed, representing a corresponding plurality of other users that meet at least one condition defined by the filter settings. Each of the plurality of indicators is selected from the predetermined list of indicators by their respective user and displayed at a location having a deliberately included error relative to the current location of the respective user.

### BRIEF DESCRIPTION OF THE DRAWINGS

FIG. 1 illustrates a schematic diagram of a system 100 associated with a social networking application;

FIG. 2 is a block diagram of an example of an implementation of a mobile device that might be used in a social networking application such as that described in this application;

FIG. 3 illustrates an example of a social networking application for a mobile device;

FIG. 4 illustrates a screenshot of a main display of one example of a social networking application in accordance with an aspect of the present invention; and

FIG. 5 illustrates a method for displaying locations of multiple users of a social networking application.

### DETAILED DESCRIPTION

The present disclosure relates generally to social applications, and is specifically drawn to an application for organizing spontaneous gatherings among users of the social application. The problem with many and most social applications is that its users are trapped in a virtual space that lacks a true catalyst to go out and meet one another in person. In our current social media-driven environment, we are connected to one other constantly, however the bulk of these connections only live within a virtual platform and as a result, true, meaningful connections are lost or never created in the first place. Most social networking applications are only used to interact with existing connections, or allow a user to “follow” another user, such as a celebrities or influential persons. It is rare for an individual to actually meet someone organically via common social networking applications. In general, in our society, it's becoming increasingly harder to meet organically and in real life. Even young people, who should be among the most social populations, are having trouble creating meaningful in-person connections. As a result, depression and teen suicides have risen dramatically over the years, with many experts contributing virtual social interaction and lack of real relationships to cause severe depression and psychological problems among teens.

Dating and friend-finder platforms, have tried to promote social interaction, however, many of these apps are focused on creating a “match” or “connection” and fall short of facilitating actual in-person meetings. On these platforms, it's only after a usually long, protracted process of messaging back and forth over days, weeks, or sometimes months, that an in-person meeting occurs. There is no “meet now” feature, which is so critical in our fast-paced, tech driven lives. Additionally, no application is directed to multiple potential user groups, such as people looking to date, people looking for friends, people looking to network within professional industries, and people looking to connect with fellow activists to stand up/create awareness for specific causes. Finally, many connection apps are just geared toward local people in the user's immediate area.

To this end, the application described in the present invention, solves this problem by facilitating in-person, spontaneous gatherings for users. The application provides an interactive map, which allows each user to dynamically select from a set of predetermined icons representing mental states and activities to denote a user's location. Accordingly, users can quickly glance at the map to see both if there are other users in a viewed location and determine what the users are doing in any given location. In one example, the set of predetermined icons includes emojis. As emojis have become a useful shorthand for written text, they provide an effective set of characters for users to share and exchange information quickly on the map display. With a single glance, the unique user interface provided by the application allows a user to view the activities of people around them or throughout the world and can decide if they want to instantly join in.

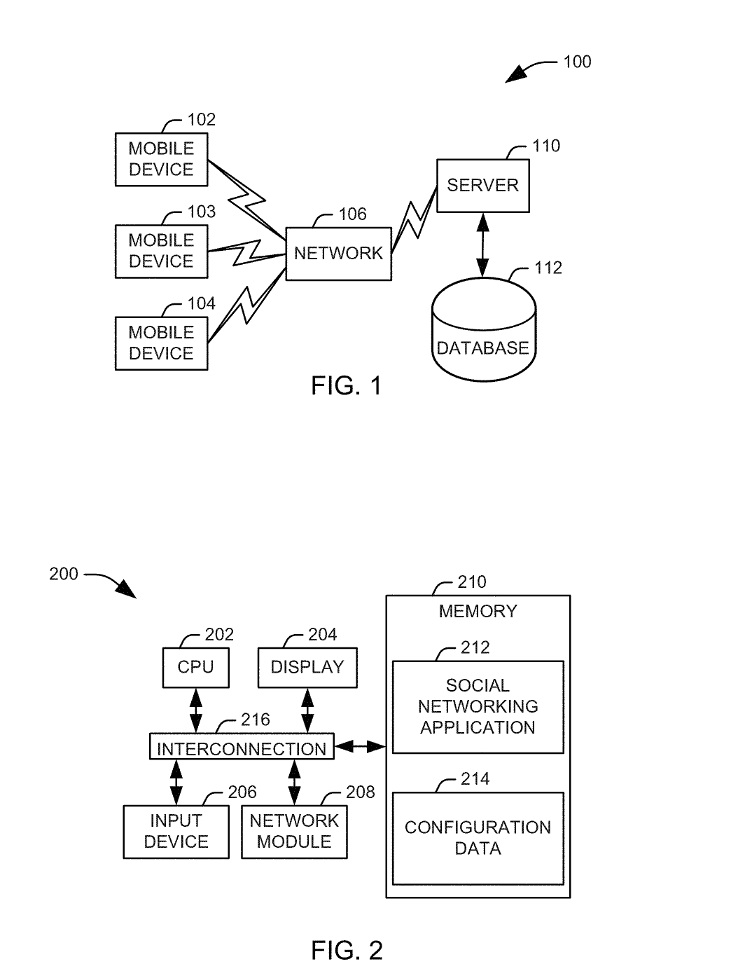

FIG. 1 illustrates a schematic diagram of a system 100 associated with a social networking application. A plurality of mobile devices 102-104 communicate via a network 106 with one another and a server 110. The server 110 can be a physical server or a virtual server, implemented, for example, as part of a virtual private cloud. A database 112 generally represents storage within the system 100 and may be used to store information provided by the mobile devices 102-104 and their users, including, for example, profile information for each user, a location of each mobile device, a filter list for each user, and locations and timing of gatherings submitted by users. The database 112 may include a relational database, an object database, or any other storage type of device. As such, the database 112 may be implemented as appropriate for a given implementation.

A given mobile device 102-104 can include, for example, a laptop computer, a cellular telephone, a personal digital assistant (PDA), a tablet computer, or any other similar device. The network 106 may include any form of interconnection suitable for the intended purpose. Generally, the network will include the Internet and, possible, a local network connected to the Internet for each phone, although it will be appreciated that with the advent of city-scale Wi-Fi systems, the social networking application could be implemented at a local level without access to a broader Internet connection. In general, due to the nature of the devices 102-104, the mechanism for connecting with the network 106 will be a cellular connection, for example, using the Long-Term Evolution (LTE) standard or a wireless network connection such as Wi-Fi.

FIG. 2 is a block diagram of an example of an implementation of a mobile device 200 that might be used in a social networking application such as that described in this application. It will be understood that many variations on implementation of a mobile device 200 are possible within the spirit of the present invention. A central processing unit (CPU) 202 provides computer instruction execution, computation, and other capabilities within the mobile device 200. A display 204 provides visual information to a user of the mobile device 200 and an input device 206 provides input capabilities for the user. The display 204 may include any display device, such as a liquid crystal display (LCD), light emitting diode (LED) display, an electronic ink display, a projector, a touchscreen, or another suitable display element or panel. The input device 206 may include a keyboard, a keypad, a mouse, a joystick, touchscreen, or any other type of input device by which the user may interact with and respond to information on the display 204.

A network module 208 allows the mobile device to communicate with via a local or wide area network with the server associated with the social networking application. The network module 208 may include any electrical, protocol, and protocol conversion capabilities useable to provide interconnection capabilities, appropriate for a given implementation. The most common examples would include the LTE standard mentioned previously for cellular communication, the 802.11 Wi-Fi standards, and the Bluetooth standard for short range communication.

A memory 210 stores the social networking application 212, along with configuration data 214, such as settings and filtering information, for the social networking application. It is understood that the memory 210 may include any combination of volatile and non-volatile memory suitable for the intended purpose, distributed or localized as appropriate. The social networking application 212 may include instructions executed by the CPU 202 for performing the functionality described herein. The CPU 202 may execute these instructions to provide the processing capabilities described above and in more detail below for the mobile device 200. The CPU 202, the display 204, the input device 206, the network module 208, and the memory 210 are interconnected via an interconnection 216. The interconnection 216 may include a system bus, a network, or any other interconnection capable of providing the respective components with suitable interconnection for the respective purpose.

Though the different elements illustrated within FIG. 2 are illustrated as component-level modules for ease of illustration and description purposes, it should be noted that these elements may include any hardware, programmed processor(s), and memory used to carry out the functions of the respective elements as described above and in more detail below. For example, the elements may include additional controller circuitry in the form of application specific integrated circuits (ASICs), processors, antennas, and/or discrete integrated circuits and components for performing communication and electrical control activities associated with the respective elements. Additionally, the elements may include interrupt-level, stack-level, and application-level modules as appropriate. Furthermore, the elements may include any memory components used for storage, execution, and data processing for performing processing activities associated with the respective elements. The elements may also form a portion of other circuitry described or may be combined without departure from the scope of the present subject matter.

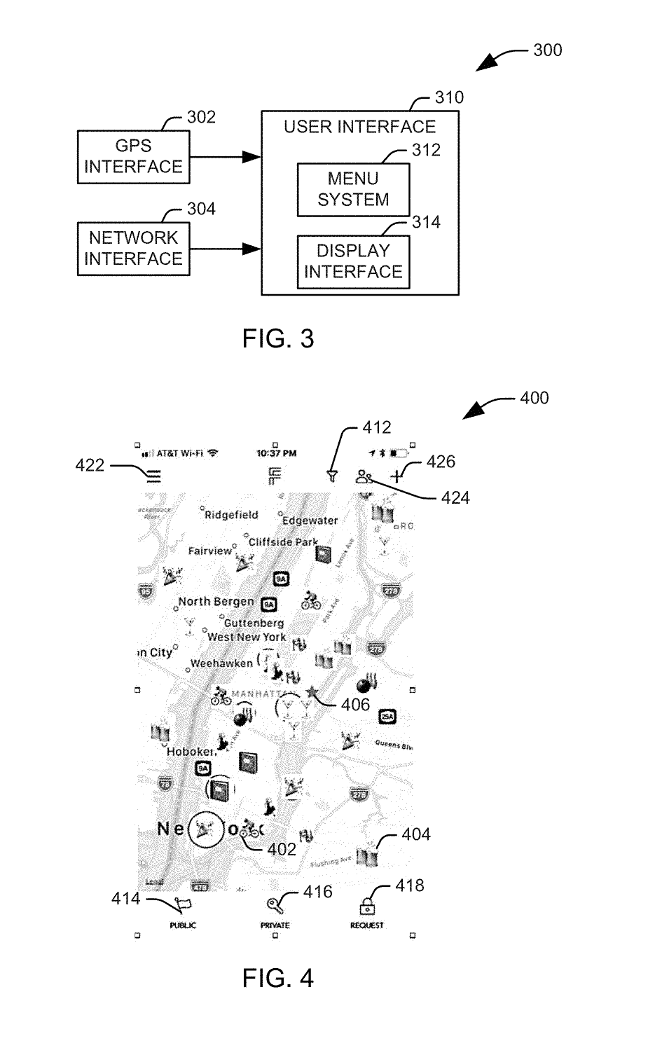

FIG. 3 illustrates an example of a social networking application 300 for a mobile device. A global positioning system interface 302 receives a location of the mobile device from a GPS associated with the device. A network interface 304 periodically sends the location of the mobile device to an associated server and receives locations associated with a plurality of users of the social networking application via an associated network connection, such that a current location of users of the social networking application 300 is maintained at the server. The network interface 304 can also send filter settings, selected by a user as described below, to the server for use in selecting the information returned to the user from the server.

A user interface 310 comprises a menu system 312 that allows a user to adjust the information provided to the user, as well as the information about the user provided to other users. The menu system 312 includes a profile option, through which edit a profile stored at the server and made available to some other users. A user profile can include, for example, an uploaded profile picture, a free text “about me” section written by the user, and a date of birth. The user can also select a set of attributes from a plurality of attributes utilized by the device filtering settings. The plurality of attributes can include a list of schools and universities, general fields of work, referred to as industries, social and charitable causes, and a list of skills. The user can select one or more schools that the user has attended, an industry in which the user works, one or more causes supported by the user, and skills in which the user is proficient. The profile menu also allows users to connect their social media accounts, such as Facebook or Instagram, for uploading photos and edit application settings, such as settings for push notifications and selection of sounds or vibration for notifications.

The menu system 312 also includes a settings option, which allows a user to change the manner in which information is displayed to themselves and others. By default, the location of a user is dynamically updated to the server, and users are discoverable by other users near this updated location. In the settings menu, a user can choose to stop displaying their location to other users. When a user chooses to stop displaying their location, the user can still view the map and view user created gatherings, however, they will not be discoverable to other users. The user can also choose to display a selected static public location. If this static public location is active, the user will remain discoverable on the map in a single location only, as opposed to being discoverable at the user's actual location, as dynamically updated at the server. This is a built-in safety feature that safeguards against unwanted contact, especially important for minors and vulnerable populations. Other options in the settings menu include setting a maximum distance at which their profile can be viewed by other users, setting a minimum and maximum age of potential connections, and selecting whether to view only current gatherings, upcoming gatherings, or all gatherings. Further, the settings menu allows a user to select an indicator to represent the user on the displays of other users. The indicator can be selected from a predetermined list of indicators representing possible activities and mental states for the first user.

The menu system 312 can further include a connections option, with allows users to create and manage connections with other users. In the connections menu, users can view their connections and accept connections with other users. Specifically, when a first user clicks “thumbs up” on a second user's profile, and the second user clicks thumbs up on the first user's profile, a match occurs which results in a connection. A connection notification is provided to each user when a match happens. user can create and edit their groups. The connections menu also includes an option for a user to create groups of connections by adding a new group and selecting existing connections to go into this group. This grouping is only visible to the user, and other users are not notified when they are put into a group. For each group, a user can upload a background photo for the group picture as well as add or delete connections within the group. The menu system 312 further includes a messages option that allows a user to send a message to a connection or to everyone within a group. It will be appreciated that the application does not allow for messages to be sent to users who are not connections, beyond the “thumbs up” system for making connections as described above.

The menu system 312 can further include a gatherings option, with allows users to create gatherings, request permission to join a gathering, and view gatherings which the user has created or to which the user has expressed an intention to attend. On an Upcoming tab of the menu, the user can view upcoming gatherings that they created or indicated an intention to attend, that is, responded “yes” to an invite from a connected user, in a list format. When a gathering from this list is selected, a user can view the gathering details, add the gathering to their schedule, or invite more people from their connections. On a Guest Requests tab, a user respond to join requests from non-connected users who want to join a specific user at gathering they are currently at or planning to attend. It will be appreciated that any attendee of a gathering can approve a request to attend a gathering. On a My Requests tab, users can view their own requests to join gatherings created by other users. The gatherings option also includes an option to create a gathering and add it to the map. On this screen, users can title the gathering, enter text details about gathering, set a date and time, enter a location and name for the gathering, choose a location on a map, select whether the gathering is private or public, and choose a theme photo for their gathering. This gathering then becomes available on the Upcoming tag to invite connections and discoverable to other users if it is public.

A display interface 314 dynamically displays a first indicator on a display of the mobile device of a first user of the social networking application representing a current location of the first user and a plurality of indicators representing a plurality of other users. It will be appreciated, however, that a location other than that of the current location can be selected, and the application will display users and gatherings within a threshold distance of the selected location. The threshold distance, as described previously, is selectable by the user in the settings menu.

To facilitate description of the display interface, FIG. 4 illustrates a screenshot 400 of a main display of one example of a social networking application in accordance with an aspect of the present invention. Each of the plurality of indicators for the other users (e.g., 402 and 404) is selected from the predetermined list of indicators by their respective user and is displayed at a location associated with the respective user. The first indicator 406, representing the user of the mobile device, can be represented as a unique indicator, such as a star, to be easily distinguishable from the other indicators. For the safety of all users, a user's broadcasted location is provided to other users with a deliberate error, instead of the actual location. Only in the user's individual view can they see their own actual location. The error can be randomly generated and applied to the provided location, or a range of locations can be shown on the map for a given user. In one implementation, the locations associated with the plurality of other users are stored at the server at a first precision and provided to the mobile device via the network interface at a second precision that is less than the first precision, such that the plurality of indicators 402 and 404 are each displayed by the display interface at a location having a deliberately induced error relative to the location stored at the server.

The default display includes the map and an icon 412 to open filter settings, allowing the user to filter the map based on user profiles. In one implementation, the filter settings can be provided to the server and used to filter the user information returned to the user. The map view displays users at their associated locations, with an option to view user profiles, and what the other users are doing, expressed by the indicators selected by the other users. It will be appreciated that the user must have their location turned on in the settings menu described above in order to be discoverable on the map. The map also displays gatherings, with public gatherings displayed with a flag icon, private gatherings to which the user is invited displayed with a key icon, and private gatherings to which the user is not invited indicated with a lock icon.

The filter icon 412 allows users to filter the map based on select criteria found in user's profiles, including the schools, industries, skills, and causes selected in their profile. A user can also filter the map to view only public gatherings, using a flag icon 414 at the bottom of the screen, private gatherings to which they are invited or a gathering to which they requested to be invited and was accepted using a key icon 416 at the bottom of the screen, and private gatherings to which they are not invited and any request to be invited was not accepted using a lock icon 418 on the bottom of the screen. A menu icon 422 allows the user to accept options in the menu system 312 as described above. A connections icon 424 opens the connections menu from the menu system 312 directly to allow a user to view and manage connections.

An add gathering icon 426, represented as a plus sign, allows the user can create a gathering. Gatherings can be created for current time or scheduled in the future, and can be public or private. If a private gathering is created, a user is prompted to invite existing connections or groups. Other non-connected users can view this private gathering on the map, represented by a lock symbol, but the details of the gathering will not be available. Non-connected users can send a request to an attending user to join the gathering, and a guest request notification will be generated to the user who created the gathering notifying them of the request. The user can choose to accept or ignore the non-connected user's request. If the non-connected user is accepted, the gathering details will be unlocked and they will receive the gathering information. The gathering symbol on the map will then change from a lock to a key at that user's device. If the user chooses to ignore the non-connected user's request, nothing will happen and the gathering details will not be revealed. If a public gathering is created, non-connected users are able to see gathering details and join. A public gathering is denoted by a flag symbol.

The user interface 310 is ideally suited for connecting people in real life who are not already connected to one another. In one example, a user can create a gathering, and another user can view the gathering and instantly join in. The upcoming tab allows users who are currently at a gathering or attending a gathering to view and connect with other attendees, and each user can also invite more connections without getting approval from the original gathering creator. In this instance, layers of people who do not know one another, but all have a similar interest can join a single gathering. As these gatherings are broad in scope and not limiting in anyway, on the fly connections between various people and groups of people can be made in real time, ranging from romantic or social dates, networking events, public protests or rallies, or any other social purpose. Additionally, users can keep in contact with its new connections through the application. In the connections tab, a user can organize their newly-made connections into groups and communicate with either a single connection or entire group directly through its messaging feature, allowing the user can schedule a future gathering with a connection or group.

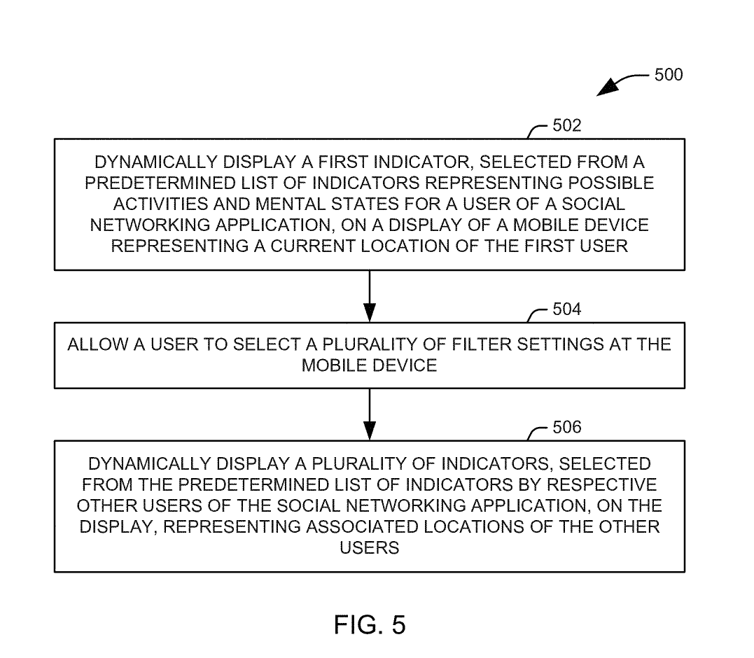

In view of the foregoing structural and functional features described above, an example method will be better appreciated with reference to FIG. 5. While, for purposes of simplicity of explanation, the example method of FIG. 5 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 5 illustrates a method 500 for displaying locations of multiple users of a social networking application. At 502, a first indicator is dynamically displayed on a display of a mobile device of a first user of the social networking application representing a current location of the first user. The first indicator is selected from a predetermined list of indicators representing possible activities and mental states for the first user. At 504, a plurality of filter settings at the mobile device by the user. The filter settings can apply, for example, to gatherings displayed by the application, which can be filtered by current or upcoming, as well as public or private. In one implementation, the user can select a time and date, and only indicators representing gatherings starting within a threshold period of time from the selected time are displayed. A given gathering indicator can have an associated interface to indicate interest in attending the event.

The filter settings can also be applied to user icons. The filter settings can include a selectable age range, such that only indicators representing users within the age range are displayed. Further, each user of the social networking application is represented by an associated profile including a set of at least one of a school that a user has attended, an industry in which a user works, a cause supported by the user, and a skill in which the user is proficient. The filter settings can therefore include a list of schools, causes, industries, and skills, and only indicators representing users whose profile contains a school, cause, industry, or skill from the list of schools, causes, industries, and skills are displayed. Additionally, the user can select a location at the mobile device, and only indicators representing users within a predetermined distance from the selected location are displayed.

A plurality of indicators representing a corresponding plurality of other users that meet at least one condition defined by the filter settings are dynamically displayed at 506. Each of the plurality of indicators is selected from the predetermined list of indicators by their respective user. It will be appreciated that the indicators are also shown only when the other users have selected a location display setting allowing for others to view the profile. In one implementation, a user can select among displaying their indicator to other users of the social networking application according a dynamically updated location, displaying their indicator to other users at a static location, and not displaying their indicator to other users of the social networking application. Even where the indicator is displayed, it can be displayed to other users at a location different than a location stored at the server, such that the indicator is displayed at the mobile device with a deliberately induced error relative to the location stored at the server. In one example, the location is stored at the server at a first precision and provided to other users at a second precision that is less than the first precision.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A method for displaying locations of multiple users of a social networking application comprising:
dynamically displaying a first indicator, representing a current location of the first user, on a display of a mobile device of a first user of the social networking application, the first indicator being selected from a predetermined list of indicators representing possible activities and mental states for the first user; and
dynamically displaying a plurality of indicators representing a corresponding plurality of other users, each of the plurality of indicators being selected from the predetermined list of indicators by their respective user and displayed at a location associated with the respective user and having an associated interface, accessible via the mobile device, to allow communication with the respective user.

2. The method of claim 1, further comprising selecting a plurality of filter settings at the mobile device, wherein dynamically displaying the plurality of indicators representing the corresponding plurality of other users comprises dynamically displaying indicators representing users comprising respective sets of attributes that meet at least one condition defined by the filter settings.

3. The method of claim 2, further comprising dynamically displaying, according to the filter settings, at least one gathering indicator representing a gathering created by a user of the social networking application at a defined location, a given gathering indicator having an associated interface, accessible via the mobile device, to indicate interest in attending the event.

4. The method of claim 3, wherein a given gathering can have an associated type, either public or private, and the filter settings include a selection of a type of gathering, such that only indicators representing gatherings of the selected type are shown.

5. The method of claim 3, wherein the filter settings include a selected time and date, and only indicators representing gatherings starting within a threshold period of time from the selected time are displayed.

6. The method of claim 2, wherein the plurality of filter settings includes a selectable age range, such that only indicators representing users within the age range are displayed.

7. The method of claim 2, wherein each user of the social networking application is represented by an associated profile including a set of at least one of a school that a user has attended, an industry in which a user works, a cause supported by the user, and a skill in which the user is proficient.

8. The method of claim 7, wherein the plurality of filter conditions comprises a list of schools, causes, industries, and skills, and only indicators representing users whose profile contains a school, cause, industry, or skill from the list of schools, causes, industries, and skills are displayed.

9. The method of claim 1, further comprising selecting a location at the mobile device, wherein dynamically displaying the plurality of indicators representing the corresponding plurality of other users comprises dynamically displaying indicators representing users within a predetermined distance from the selected location.

10. The method of claim 1, wherein dynamically displaying a plurality of indicators representing a corresponding plurality of other users comprises displaying the plurality of indicators at locations different than respective locations stored at the server for the plurality of other users, such that each of the plurality of indicators are displayed at the mobile device with a deliberately induced error relative to the location stored at the server.

11. The method of claim 10, wherein the locations associated with the plurality of other users are stored at the server associated with the social networking application at a first precision and provided to the mobile device at a second precision that is less than the first precision.

12. The method of claim 1, further comprising selecting, at the mobile device, at location display setting comprising one of displaying an indicator representing the first user to other users of the social networking application according to a location of the first user, displaying the indicator representing the first user to other users of the social networking application according to a static location selected by the first user, and not displaying the indicator representing the first user to other users of the social networking application.

13. A social networking application for a mobile device comprising:
a global positioning system interface that receives a location of the mobile device from a GPS associated with the device;
a network interface that periodically sends the location of the mobile device to an associated server and receives locations associated with a plurality of users of the social networking application via an associated network connection; and
a user interface comprising:
a menu system that allows a first user to select an indicator from a predetermined list of indicators representing possible activities and mental states; and
a display interface that dynamically displays a first indicator on a display of the mobile device of a first user of the social networking application representing a current location of the first user and a plurality of indicators representing the plurality of users, each of the plurality of indicators being selected from a predetermined list of indicators representing possible activities and mental states of the user by their respective user, being displayed at a location associated with the respective user, and having an associated interface to allow communication with the respective user.

14. The social networking application of claim 13, wherein the menu system further allows the first user to select a plurality of filter settings at the mobile device and the network interface sends the filter settings to the server, wherein the plurality of users only include users of the social networking application with respective sets of attributes that meet at least one condition defined by the filter settings.

15. The social networking application of claim 14, the network interface further receiving a location of a gathering, created by a user of the social networking application at a defined location, from the server according to the plurality of filter settings, and the display interface dynamically displaying a gathering indicator representing the gathering and having an associated interface to indicate interest in attending the event.

16. The social networking application of claim 13, the menu system allowing the first user to select a location, wherein dynamically displaying the plurality of indicators representing the corresponding plurality of other users comprises dynamically displaying indicators representing users within a predetermined distance from the selected location.

17. The social networking application of claim 13, wherein the locations associated with the plurality of other users are stored at the server at a first precision and provided to the mobile device via the network interface at a second precision that is less than the first precision, such that the plurality of indicators are each displayed by the display interface at a location having a deliberately induced error relative to the location stored at the server.

18. The social networking application of claim 13, the menu system allowing a user to select a location display setting comprising one of displaying an indicator representing the first user to other users of the social networking application according to a location of the first user, displaying the indicator representing the first user to other users of the social networking application according to a static location selected by the first user, and not displaying the indicator representing the first user to other users of the social networking application.

19. A method for displaying locations of multiple users of a social networking application comprising:
dynamically displaying a first indicator, representing a current location of the first user, on a display of a mobile device of a first user of the social networking application, the first indicator being selected from a predetermined list of indicators representing possible activities and mental states for the first user;
selecting a plurality of filter settings at the mobile device; and
dynamically displaying a plurality of indicators representing a corresponding plurality of other users that meet at least one condition defined by the filter settings, each of the plurality of indicators being selected from the predetermined list of indicators by their respective user and displayed at a location having a deliberately included error relative to the current location of the respective user.

20. The method of claim 19, further comprising dynamically displaying, according to the filter settings, at least one gathering indicator representing a gathering created by a user of the social networking application at a defined location, a given gathering indicator having an associated interface, accessible via the mobile device, to indicate interest in attending the event.
